(19) United States
(12) Patent Application Publication
(10) Pub. No.: US 2012/0233254 A1
(43) Pub. Date: Sep. 13, 2012

(54) COMMUNICATION SYSTEM AND COMMUNICATION METHOD

(75) Inventor: Akihiko Koizuka, Tokyo (JP)

(73) Assignee: DWANGO CO., LTD., Tokyo (JP)

(21) Appl. No.: 13/393,875

(22) PCT Filed: Nov. 18, 2010
(86) PCT No.: PCT/JP2010/070543

§ 371 Date: Mar. 2, 2012

(30) Foreign Application Priority Data
Dec. 1, 2009 (JP) 2009-273540

(51) Int. Cl. G06F 15/16

(52) U.S. Cl. 709/204

(57) ABSTRACT

In a communication system which includes: a comment server that delivers to user terminals comments that are input in response to contents which are played by the user terminals, and comment input times that show the point in time when a comment was input with the contents playing start time used as a reference; and user terminals that are connected to this server, the user terminals play received contents, and also sort the plurality of comments which are delivered to it from the comment server to each one of a plurality of time segments based on the comment input time corresponding to each comment, and also output in synchronization with the contents a predetermined number of comments for each time segment.

### TECHNICAL FIELD

The present invention relates to a communication system and a communication method in which comments that are input so as to match the progress of played contents are shared between a plurality of user terminals.

Priority is claimed on Japanese Patent Application No. 2009-273540, filed Dec. 1, 2009, the contents of which are incorporated herein by reference.

### BACKGROUND ART

Communication services are available to deliver comments transmitted from a plurality of user terminals that are connected together via a network, and provide a site for communication between users. For example, Patent document 1 discloses a chat service to which a large number of user terminals can connect. Moreover, in recent years, communication services have been provided that share between a plurality of user terminals comments which are input into the user terminals following the progress of contents being played on the user terminals, so that these are displayed on a contents screen.

### DOCUMENTS OF THE PRIOR ART

### Patent Documents

Patent document 1 Japanese Unexamined Patent Application, First Publication No. H10-334021

### DISCLOSURE OF INVENTION

### Problem to be Solved by the Invention

However, in a communication service of this kind, even if all of the comments transmitted from a large number (for example, tens of thousands) of user terminals are delivered to all of the user terminals, it is difficult for the users of the user terminals who receive this huge number of comments to read and comprehend all of the comments. Furthermore, in this case, an excessive load is placed on the comment server, the network, and the user terminals. For this reason, limiting in advance the number of comments than can be displayed in relation to a single content item might be considered. However, for example, as is shown in FIG. 6, in some cases the comments are concentrated in a particular time period during the playing time of some contents. In these cases, a large number of comments are only displayed during this particular time period, while in other time periods, there may be absolutely no comments whatsoever displayed. Namely, while a number of comments which too large for a user to comprehend may be displayed during periods of concentrated comments, absolutely no comments whatsoever are displayed during periods when no comments are submitted. Accordingly, it is thought that cases may arise in which it is difficult for each user to communicate smoothly with relating to the content of input comments to occur.

The present invention was conceived in view of the above described circumstances. The present invention provides a communication system and a communication method that, in a communication service that plays contents and also outputs comments which are input in response to those contents, controls comment output so that comments are prevented from becoming too concentrated in particular time periods while the contents are being played, and so as to prevent comments from not being output during other time periods.

### Means for Solving the Problem

In order to solve the above described problems, the communication system of the present invention includes: a comment server that stores, as comment information, a plurality of comments that are input in response to contents and comment input times indicative of times when the plurality of comments are input in association with each other, and delivers the comment information; and user terminals including: an output section that displays the contents that are delivered from the contents server and a plurality of the comments that are included in the comment information delivered from the comment server; and an output control section that, based on the comment input times of the comments, sorts each of the comments into one of a plurality of time segments created by dividing playing time of the contents, and causes the output section to display the comments whose number is less than or equal to a predetermined number determined for each of the time segments.

In the communication system of the present invention, when a number of the comments is less than the predetermined number in a particular time segment among the time segments, it is also possible for the output control section of the user terminal to further receive the comment information newly delivered from the comment server and to be sorted in the particular time segment when playing the contents begins.

Moreover, in the communication system of the present invention, it is also possible for the output control section of the user terminal to receive the comment information newly delivered from the comment server while the contents are being played, and to continue to display the comments included in the received comment information until a number of the comments reaches the predetermined number.

Moreover, in the communication system of the present invention, it is also possible for the user terminal to be provided with: a first time segment determining section that creates time segment identifying information that identifies the time segments corresponding to the comment input times; and with a comment transmitting section that transmits to the comment server the comments to be input and the time segment identifying information created by the first time segment determining section.

Moreover, in the communication system of the present invention, it is also possible for the comment server to be provided with a second time segment determining section that creates time segment identifying information that identifies the time segments corresponding to the comment input times transmitted from the user terminals.

Moreover, in the communication system of the present invention, it is also possible for the comment server to be provided with: a comment storage section that stores the comments transmitted from the plurality of user terminals in association with each of the time segments; and a comment delivery section that receives from the user terminals comment acquisition requests specifying the time segments, and reads from the comment storage section the comment information which includes the time segment specified by the received comment acquisition request so as to deliver the comment information to the user terminal that transmitted the comment acquisition request.

Furthermore, the communication method of the present invention includes: delivering to the user terminal a plurality of comments that are input in response to contents played on a user terminal, as well as comment input times indicative of times when the comments are input; sorting each of the comments into one of a plurality of time segments created by dividing playing time of the contents based on the comment input times by the user terminal; and playing the contents in the user terminal, and displaying the comments whose number is less than or equal to a predetermined number determined for each of the time segments together with the contents based on their comment input times.

### Effect of the Invention

As has been described above, according to the present invention, comments that are input into user terminals in accordance with contents which are being played by the user terminals, and comment input times that are associated with the comments and that show the point in time when a comment was input, with the contents playing start time used as a reference, are received from user terminals, and the user terminals that are connected to a comment server that delivers comments to the plurality of user terminals play received contents, and also sort or allocate each of the plurality of comments which are delivered from the comment server to each one of a plurality of time segments in accordance with the comment input time of each comment, and also output a particular number of comments which has been predetermined for each time segment. Accordingly, it is possible for the number of comments that are output in each time segment to be less than or equal to a set number, so that it is possible to prevent comments from becoming excessively concentrated only in specific time periods where the comments are concentrated, and comments can be also output in time periods other than those time periods where the comments are concentrated.

### BRIEF DESCRIPTION OF THE DRAWINGS

FIG. 1 is a block diagram showing a communication system according to an embodiment of the present invention.

FIG. 2 is a view showing a screen displayed on a user terminal according to an embodiment of the present invention.

FIG. 3 is a graph showing an example of comment numbers divided into time segments according to an embodiment of the present invention.

FIG. 4 is a view showing data stored in a comment storage section according to an embodiment of the present invention.

FIG. 5 is a sequence diagram showing operations of the communication system according to an embodiment of the present invention.

FIG. 6 is a graph showing the concentration of comments in a conventional communication system.

### EMBODIMENTS FOR CARRYING OUT THE INVENTION

Hereinafter, an embodiment of the present invention will be described with reference made to the drawings.

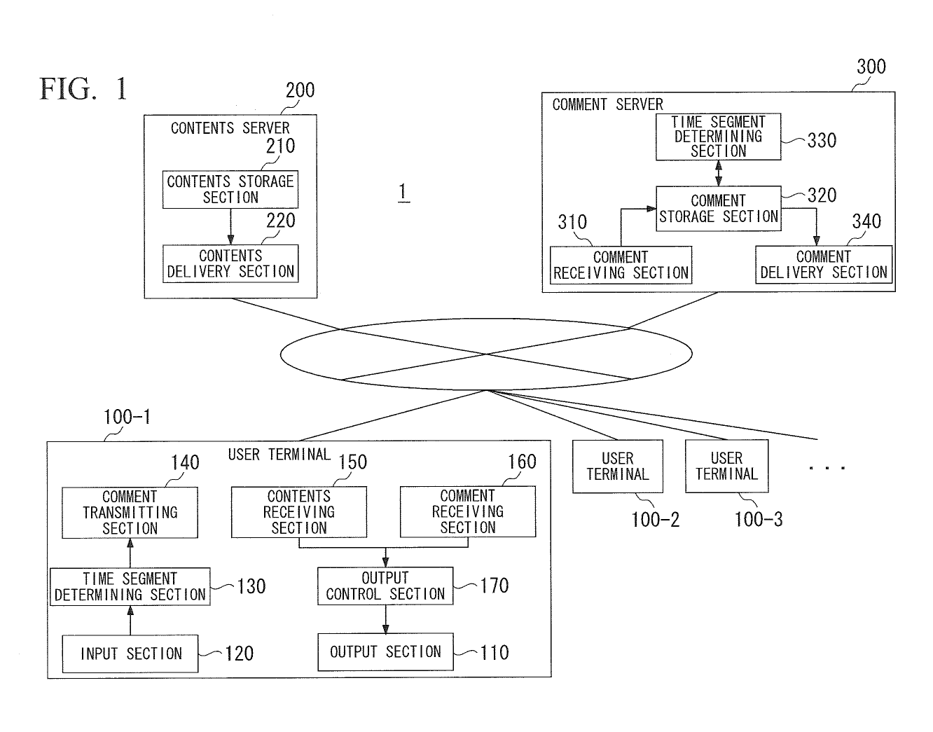

FIG. 1 is a block diagram showing the structure of a communication system 1 according to the present embodiment. The communication system 1 is provided with a plurality of user terminals 100 (i.e., a user terminal 100-1, a user terminal 100-2, a user terminal 100-3, . . . a user terminal 100-n, . . . a user terminal 100-N) a contents server 200, and a comment server 300. These component elements are formed by computer devices and are connected together via a network. Here, because the plurality of user terminals 100-N (wherein N is an arbitrary integer) have the same structure, other than when any special distinction is to be made, the generic descriptor ‘user terminals 100’ is used.

The user terminal 100 is a computer device which plays the contents delivered from the contents server 200, and attaches comments delivered from the comment server 300 to these contents and outputs the result. The user terminal 100 is provided with an output section 110, an input section 120, a time segment determining section 130, a comment transmitting section 140, a contents receiving section 150, a comment receiving section 160, and an output control section 170.

The output section 110 outputs contents which are delivered from the contents server 200, and comments which are delivered from the comment server 300.

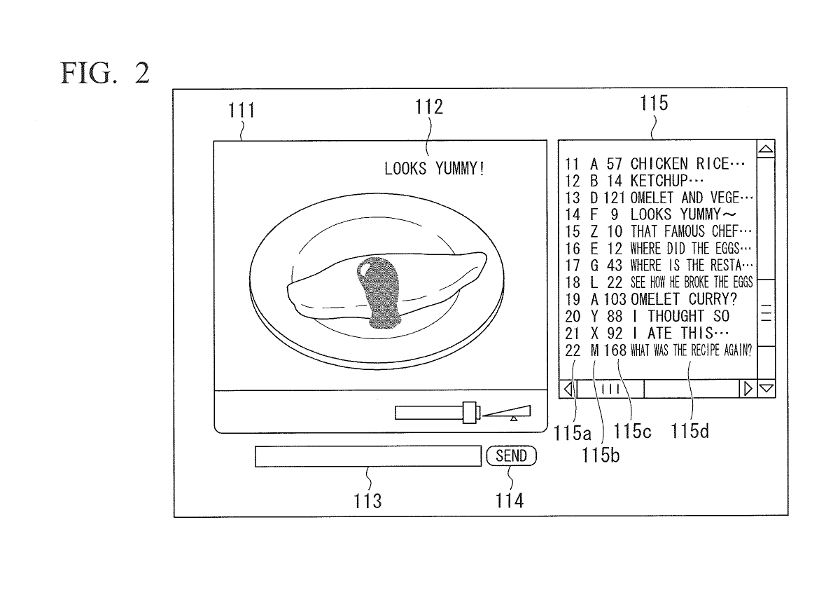

FIG. 2 shows an example of a screen displayed on the user terminal 400. Here, an example in which contents in the form of video information are played is shown. Video delivered from the contents server 200 and a comment 112 transmitted from another user terminal 100 and delivered by the comment server 300 are displayed superimposed one on top of the other in a play area 111 within the screen. The comment 112 delivered from the comment server 300 is displayed so that it scrolls smoothly over the video from the right to the left. As a result, while viewing the video, a user of this communication service is able to share comments which are input in accordance with the video content with other users, and thus achieve communication with other users.

Comments are input from users via the input section 120 into an input form 113. When a user clicks a send button 114, the comment that has been input into the input form 113, the comment input time, video identification information, and user identification information and the like are transmitted to the comment server 300. Here, the comment input time refers to the elapsed time from the point when the playing of the contents was started until the point when the comment was input (i.e., a time showing the point when a comment was input with the contents playing start time taken as a reference).

A comment list display area 115 is an area where comments input from a plurality of users are displayed. Comments listed in this manner are received at regular intervals from the comment server 300 by the comment receiving section 160 of the user terminal 100, and are stored in a storage area of the user terminal 100. Numbers 115a which show the submission sequence of each comment, usernames 115b of the users who input the comments, comment submission times 115c showing when the comments were sent, and portions 115d of the submitted comments are displayed in the sequence of the time at which they were submitted in the comment list display area 115. In FIG. 2, the comment submission times 115c are displayed as the number of seconds that have elapsed from the point when the playing of the contents was started until the point when the comment was input.

The input section 120 is a device such as a keyboard or a mouse, and receives, for example, inputs of text which are input into the aforementioned input form 113, and inputs when the send button 114 is pressed.

The time segment determining section 130 creates time segment identifying information which identifies time segments that correspond to comment input times which show the points in time when comments were input into the input section 120. Namely, using the contents playing start time which is output to the output section 110 as a reference, the time segment determining section 130 determines the comment input times of comments input into the input section 120, and the time segments that correspond to these comment input times. If the time segment determining section 130 divides the contents into time segments of 1 minute each, then if the contents playing time is 5 minutes, the contents playing time is divided into 5 time segments, and the time segment identifiers I1, I2, I3, I4, and I5 that identify each time segment are allocated to the respective time segments. Next, if the comment input time of an input comment is 5 seconds, the time segment identifying section 130 creates the identifier I1 as the time segment identifying information for this comment, while if the comment input time of an input comment is 2 minutes 30 seconds, the time segment identifying section 130 creates the identifier I3 as the time segment identifying information for this comment.

The comment transmitting section 140 transmits the comments input into the input section 120, the comment input times of these comments, and the time segment identifying information items I1 to I5 which have been determined by the time segment determining section 130 to the comment server 300.

The contents receiving section 150 receives contents delivered from the contents server 200.

The comment receiving section 160 receives comments delivered from the comment server 300.

The output control section 170 outputs contents received by the contents receiving section 150 and comments received by the comment receiving section 160 to the output section 110. By supplying these contents to the output section 110, the output control section 170 plays the contents. The output control section 170 outputs the plurality of comments which are input to these contents to the output section 110 in accordance with the comment input time of the comments, however, it controls such outputs such that the number of comments which are output is within a previously determined upper limit (i.e., a comment holding number) in each time segment.

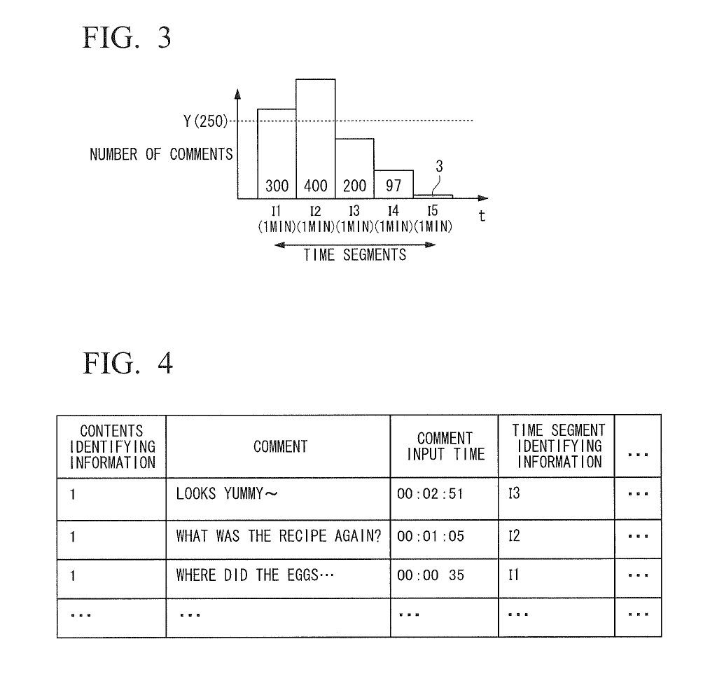

FIG. 3 shows an example of comment numbers output in each time segment by the output control section 170. The time segment units are set at 1 minute, and the contents playing time is 5 minutes. In this case, the contents playing time is divided into the five time segments I1 to I5. When the output control section 170 receives via the comment receiving section 160, for example, 1000 comments from the comment server 300, as well as the comment input times for each comment, it sorts or allocates the received comments into the respective time segments in accordance with their comment input times. In the example shown in FIG. 3, 300 comments are sorted into the time segment I1, 400 comments are sorted into the time segment 12, 200 comments are sorted into the time segment I3, 97 comments are allocated to the time segment I4, and 3 comments are sorted into the time segment I5. If a comment holding number Y is 250, then because the comment holding number is exceeded in the time segments I1 and I2, any comments over 250 are excluded from those targeted for output, and only the comments targeted for output actually are output. When the comments in excess of the comment holding number are excluded from the comments targeted for output, they are excluded in sequence starting from the comment which had the earliest transmission timing to the comment server 300.

When the output control section 170 starts the playing of the contents, it once again receives the latest plurality of comments from the comment server 300 via the comment receiving section 160. Namely, if, in the divided time segments, there are time segments in which the number of sorted of allocated comments has not reached a previously determined upper limit (i.e., the comment holding number), comments that should be sorted to those time segments continue to be received from the comment server 300. The comment holding number is stored in advance in the storage area of the output control section 170.

In the example shown in FIG. 3, as is described above, at the point in time when the output control section 170 starts the playing of the contents, it receives the latest plurality of comments from the comment server 300 and sorts or allocates the comments to the respective time segments. Because the comment holding number of each time segment is 250, the number of comments in the time segments I1 and I2 exceeds the comment holding number. In contrast, the number of comments in the time segments I3, I4, and I5 does not reach the comment holding number. The output control section 170 transmits to the comment server 300 an acquisition request for comments that should be sorted into the time segments I3, I4, and I5 in which the number of comments has not yet reached the comment holding number, and acquires the shortfall amount of comments via the comment receiving section 160. The received comments are then sorted into the respective time segments in the same way as that described above.

The output control section 170 continues to receive new comments delivered from the comment server 300 while it is playing the contents, and outputs the received comments to the output section 110 as long as the number of received comments has not exceeded the previously set upper limit. Namely, even while contents are being played on a user terminal 100, new comments are input from other user terminals 100 about those contents and are transmitted to the comment server 300. The comment receiving section 160 acquires these new comments from the comment server 300 by polling. The output control section 170 also targets for outputting these new comments acquired by the comment receiving section 160 in this manner.

Referring once again to FIG. 1, the contents server 200 is a computer device which delivers contents to a plurality of user terminals 100. The contents server 200 is provided with a contents storage section 210, and a contents delivery section 220.

Contents which are delivered to the user terminals 100 are stored in the contents storage section 210. The contents that are stored in the contents storage section 210 include, for example, information such as video or audio that has a fixed length playing time, and may include, for example, video information about a cooking program that has been previously recorded, or a music video, or a game video or the like.

The contents delivery section 220 delivers the contents stored in the contents storage section 210 in accordance with contents delivery requests transmitted from the user terminals 100.

The comment server 300 is a computer device that receives from the user terminals 100 comments that are input from the user terminals 100 in response to particular contents, as well as comments input times for those comments (i.e., a time that shows the point when a comment was input with the time when the playing of the contents was started taken as a reference), and that accumulates received comments and comments input times and delivers them to a plurality of user terminals 100. The comment server 300 is provided with a comment receiving section 310, a storage section 320, a time segment determining section 330, and a comment delivery section 340.

The comment receiving section 310 receives comments and comment input times that are transmitted from the user terminals 100, and stores them in the comment storage section 320. As is described below, it is also possible for the comment receiving section 310 to receive time segment identifying information from the user terminals 100.

Comments which are provided for contents are stored in the comment storage section 320. As is shown in FIG. 4 which shows a data structure of the comment storage section 320, contents identifying information which identifies the contents for which a particular comment is provided, the comment, the comment input time for the comment, and time segment identifying information for that comment are associated with each other and are stored as comment information in the comment storage section 320. Here, the input time is shown in an hh (hour): mm (minute): ss (second) format, however, it may also be shown using only the number of seconds. Moreover, the comment information stored in the comment storage section 320 has a structure that enables the sequence in which the comment information was stored in the comment storage section 320 to be identified. For example, it is also possible for the timing at which a comment was stored to be associated with that comment in the comment storage section 320, and for comment identifying information that is incremented each time new comment information is added to be associated with each comment in the comment storage section 320. By employing this method, when reading comments which are stored in the comment storage section 320, it is possible, for example, to read only the desired number of the latest comment data items.

The time segment determining section 330 has the same type of functions as the time segment determining section 130 of the user terminal 100. Namely, the time segment determining section 330 first divides the playing time of the subject contents into predetermined time segments. Next, based on the comment input times stored in the comment storage section 320, the time segment determining section 330 determines time segments that correspond to the input times of comments which relate to the contents, and store the identifiers of the determined time segments in the comment storage section 320 as time segment identifying information.

In the case of comment information whose time segment identifying information has already been determined and created in the user terminal 100 and transmitted, the time segment identifying information that corresponds to this has already been stored in the comment storage section 320, however, in this manner, it is also possible for the time segments to be determined by the time segment determining section 330 of the comment server 300.

In this manner, if the time segment determining section 330 of the comment server 300 determines time segments in accordance with the comment input time points, and then creates time segment identifying information, it is not necessary for the user terminals 100 to be provided with the time segment determining section 130.

Moreover, in cases in which communication systems that are already operating exist, and comment information which does not contain time segment identifying information is accumulated in the servers, then it is also possible for that comment information to be stored in the comment server 300 so that time segment identifying information can be added to this existing comment information by the time segment determining section 330, and the resulting information then can be stored.

The comment delivery section 340 delivers contents stored in the comment storage section 320 to the user terminals 100. Moreover, the comment delivery section 340 also receives comment acquisition requests specifying the time segment from the user terminals 100, and reads from the comment storage section 320 the comments that are sorted or allocated into the time segment specified by the received comment acquisition requests. The read comments are then delivered to the user terminals 100 that transmitted the comment acquisition requests. Here, it is also possible for the comment delivery section 340 to deliver a number of comments which is less than or equal to the upper limit determined in advance for each time segment to the user terminals 100.

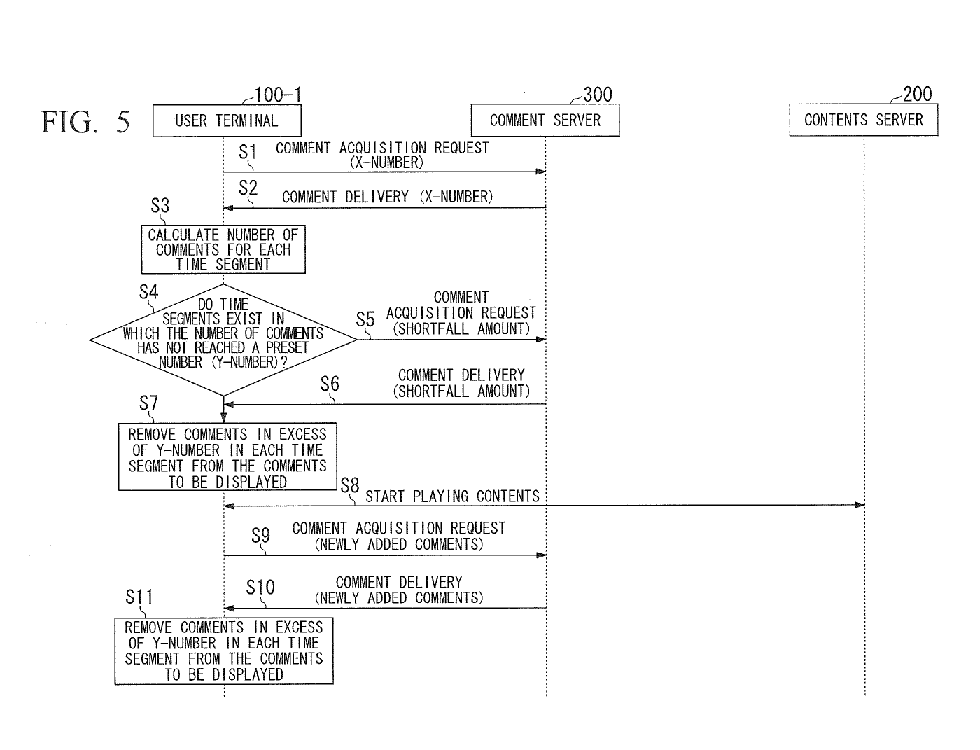

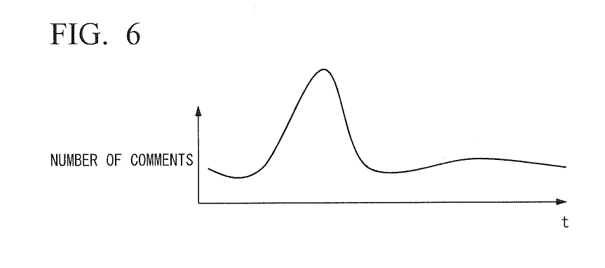

Next, an operation of the communication system 1 according to the present embodiment will be described. FIG. 5 is a sequence diagram showing the flow of commands, comments, and contents between a user terminal 100-1, the comment server 300, and the contents server 200 in the communication system 1.

Firstly, the user terminal 100-1 transmits a comment acquisition request to the comment server 300 requesting the acquisition of x-number of (for example, 1000) comments that have been contributed for the contents which is about to play (step S1). When the comment server 300 receives this comment acquisition request, the comment delivery section 340 reads from the comment storage section 320 the x-number of comments that satisfy the request, and delivers them to the user terminal 100-1 (step S2).

When the comment receiving section 160 of the user terminal 100 receives the comments delivered from the comment server 300, the output control section 170 sorts or allocates the 1000 received comments into the set time segments in accordance with their comment input times, and calculates the number of comments in each time segment (step S3). Next, the output control section 170 determines whether or not time segments are present among the respective time segments in which the number of comments sorted or allocated thereto has not reached the comment holding number (step S4).

If the output control section 170 determines that there are no time segments in which the number of comments has not reached the comment holding number (step S4: NO), the routine moves to step S7. If, on the other hand, in step S4, the output control section 170 determines that a time segment is present in which the number of comments has not reached the comment holding number (step S4: YES), the user terminal 100-1 transmits to the comment server 300 a comment acquisition request for the comments that should be sorted or allocated (i.e., for the shortfall amount thereof) to the time segments where the comment holding number has not been reached.

When the comment server 300 receives the comment acquisition request for the shortfall amount transmitted from the user terminal 100-1, the comment delivery section 340 reads comments that will satisfy the request from the comment storage section 320, and delivers them to the user terminal 100-1 (step S6). When the comment receiving section 160 of the output control section 170 of the user terminal 100-1 receives the comments delivered from the comment server 300, the output control section 170 sorts or allocates the received comments to their respective time segments in accordance with their comment input times. Furthermore, the output control section 170 removes comments that have exceeded the comment holding number in each time segment from the comments which are targeted for display (step S7). For example, by deleting comments that have been received by the comment receiving section 160 and stored in the storage areas, the output control section 170 excludes the comments that exceed the comment holding number from the comments which are targeted for display.

The output control section 170 outputs contents that have been acquired from the contents server 200 by the contents receiving section 150 and also plays these contents. In addition, the output control section outputs comments that it has determined to be subjects for display in accordance with the comment input times (step S8).

Furthermore, at the same time as it is playing such contents, the output control section 170 also transmits at regular intervals to the comment server 300 comment acquisition requests for newly added comments (step S9), and performs polling of the comment acquisition requests. The comment delivery section 340 of the comment server 300 reads new comments from the comment storage section 320, and delivers them to the user terminal 100-1 (step S10). When the output control section 170 receives the comments delivered from the comment server 300, it removes from the comments that are targeted for display in each time segment those comments which exceed the comment holding number in sequence from the oldest one (step S11).

As has been described above, according to the present invention, in a communication service that, in addition to playing contents, outputs comments that are input in response to the contents, it is possible to equalize the number of comments that are output over different periods. Accordingly, it is possible to prevent comments becoming too concentrated in a particular time period during the playing of contents, and to prevent comments not being output during other time periods.

In the present embodiment, when the contents playing time was divided, it was broken down into 1-minute time segments and the comment holding numbers in all of the time segments were made the same. However, if, for example, a fractional number occurs in the time segments, then a number of comments that fits in with the fractional number may be set as the comment holding number. For example, if the contents playing time is 4 minutes 30 seconds, then if this is to be divided into time segments of 1 minute, the contents playing time is divided into four time segments of 1 minute and one time segment of 30 seconds. If the comment holding number per 1-minute time segment is 250, then in the 30 second time segment 125 (250×(30/60)) comments are set as the comment holding number.

Moreover, the time segments into which the comments are divided may also be set as variable time segments in accordance with the nature of the contents or the like. For example, if, in accordance with the nature of the contents, divisions exist such as first act, second act, and the like, then time segments can be set to match those divisions. Alternatively, in contents such as a play, the time segments may be set in accordance with the scene in which each new character first appears. Furthermore, in the case of contents for which no start time or end time has been set when they are being played, but which are instead being broadcast in real time, it is possible to create and input time segment identifying information in accordance with the comment input times, and deliver comments in accordance with a comment holding number which has been determined for each time segment.

It is also possible for the value of the comment holding number in each time segment to be stored as a fixed value in the comment server 300, or for it to be able to be changed dynamically. For example, it is possible for a different comment holding number to be stored for each item of contents in the contents server 200, and for this to be delivered to the user terminals 100 together with attribute information for the contents such as the number of times the contents have been played or the like. It is also possible for a different comment holding number to be set for each user, and for this to be delivered from the login server to the user terminal 100 when a user logs in. It is also possible for the input of an arbitrary comment holding number to be received in the user terminal, and for the input comment holding number to be applied. It is also possible for an average value of the number of comments in each time segment to be applied as the comment holding number for comments that are associated with specific contents and stored in the comment storage section 320.

Note that it is also possible to record a program that achieves the functions of the processing sections of the present invention on a computer-readable recording medium, and to provide a communication service by causing a computer system to read and execute the program recorded on this recording medium. Note that the term ‘computer system’ used here includes both OS and hardware such as peripheral devices and the like.

Moreover, ‘computer system’ may also include a WWW system which is provided with a homepage providing environment (or display environment). Moreover, the term ‘computer readable recording medium’ also refers to portable media such as flexible disks, magneto-optical disks, ROM, and CD-ROM and the like, and storage devices such as hard disks that are built into a computer system. Furthermore, ‘computer readable recording medium’ also includes devices that hold a program for a fixed time such as the internal volatile memory (RAM) in a computer system which forms the server or client when the program is transmitted via a network such as the Internet or via a communication line such as a telephone line.

Moreover, the aforementioned program may also be transmitted from a computer system in which the program is stored on a storage device or the like to another computer system via a transmission medium, or via a transmission wave within the transmission medium. Here, the term ‘transmission medium’ which transmits the program refers to a medium having a function of transmitting information such as a network such as the Internet or a communication line such as a telephone line. Moreover, the above described program may also be designed to fulfill a portion of the above described functions. Furthermore, the aforementioned program may also achieve the above described functions in combination with a program which is already recorded on the computer system, or may be what is known as a differential file (i.e., a differential program).

### INDUSTRIAL APPLICABILITY

The present invention can be used in a communication system in which comments which are input in accordance with the progress of played contents are shared between a plurality of user terminals, and is able to equalize the number of comments in each time segment that are displayed during the contents playing time.

### Reference Symbols

1 Communication system

100 User terminal

110 Output section

120 Input section

130 Time segment determining section

140 Comment transmitting section

150 Contents receiving section

160 Comment receiving section

170 Output control section

200 Contents server

210 Contents storage section

220 Contents delivery section

300 Comment server

310 Comment receiving section

320 Comment storage section

330 Time segment determining section

340 Comment delivery section

1. A communication system comprising:
a comment server that stores, as comment information, a plurality of comments that are input in response to contents and comment input times indicative of times when the plurality of comments are input in association with each other, and delivers the comment information; and
user terminals including: an output section that displays the contents that are delivered from the contents server and a plurality of the comments that are included in the comment information delivered from the comment server; and an output control section that, based on the comment input times of the comments, sorts each of the comments into one of a plurality of time segments created by dividing playing time of the contents, and causes the output section to display the comments whose number is less than or equal to a predetermined number determined for each of the time segments.

2. The communication system according to claim 1, wherein the output control section further receives the comment information newly delivered from the comment server and to be sorted in a particular time segment when a number of the comments is less than the predetermined number in the particular time segment among the time segments at the start of displaying the contents.

3. The communication system according to claim 1, wherein the output control section receives the comment information newly delivered from the comment server while the contents are being displayed, and continues to display the comments included in the received comment information until a number of the comments reaches the predetermined number.

4. The communication system according to claim 1, wherein the user terminal includes:
a first time segment determining section that creates time segment identifying information that identifies the time segments corresponding to the comment input times; and
a comment transmitting section that transmits to the comment server the comments to be input and the time segment identifying information created by the first time segment determining section.

5. The communication system according to claim 1, wherein the comment server includes a second time segment determining section that creates time segment identifying information that identifies the time segments corresponding to the comment input times transmitted from the user terminals.

6. The communication system according to claim 1, wherein the comment server includes:
a comment storage section that stores the comments transmitted from the plurality of user terminals in association with each of the time segments; and
a comment delivery section that receives from the user terminals comment acquisition requests specifying the time segments, and reads from the comment storage section the comment information which includes the time segment specified by the received comment acquisition request so as to deliver the comment information to the user terminal that transmitted the comment acquisition request.

7. A communication method comprising:
delivering to the user terminal a plurality of comments that are input in response to contents played on a user terminal, as well as comment input times indicative of times when the comments are input;
sorting each of the comments into one of a plurality of time segments created by dividing playing time of the contents based on the comment input times by the user terminal; and
playing the contents in the user terminal, and displaying the comments whose number is less than or equal to a predetermined number determined for each of the time segments together with the contents based on their comment input times.

8. A user terminal comprising:
a contents receiving section which receives content delivered from outside;
a comment receiving section which receives a plurality of comments input in response to the content and comment input times indicative of times when the plurality of the comments are input in association with each other;
an output section which displays the content and the plurality of the comments; and
an output control section that, based on the comment input times, sorts each of the comments into one of a plurality of time segments created by dividing playing time of the content, and causes the output section to display the comments whose number is less than or equal to a predetermined number determined for each of the time segments.

9. The user terminal according to claim 8, wherein the output control section further receives, via the comment receiving section, a new comment to be sorted in a particular time segment and the comment input time associated with the new comment when a number of the comments is less than the predetermined number in the particular time segment among the time segments at the start of displaying the content.

10. The user terminal according to claim 8, wherein the output control section further receives a new comment and the comment input time associated with the new comment via the comment receiving section while the content is being displayed, and continues to display the new comment until a number of the comments reaches the predetermined number.

11. A method for displaying comments comprising the steps of:
receiving content delivered from outside by a contents receiving section;
receiving a plurality of comments input in response to the content and comment input times indicative of times when the plurality of the comments are input in association with each other by a comment receiving section;
sorting each of the comments into one of a plurality of time segments created by dividing playing time of the content based on the comment input times; and
causing a display to display the content along with the comments whose number is less than or equal to a predetermined number determined for each of the time segments.

12. A computer readable media storing a program for making a computer functioning as a user terminal execute the steps of:
receiving content delivered from outside by a contents receiving section;
receiving a plurality of comments input in response to the content and comment input times indicative of times when the plurality of the comments are input in association with each other by a comment receiving section;
sorting each of the comments into one of a plurality of time segments created by dividing playing time of the content based on the comment input times; and
causing a display to display the content along with the comments whose number is less than or equal to a predetermined number determined for each of the time segments.
